(19) United States
(12) Patent Application Publication
(10) Pub. No.: US 2010/0043730 A1
(43) Pub. Date: Feb. 25, 2010

(54) HYDROGEN GENERATING SYSTEM FOR OPERATION WITH ENGINE TURBO CONDITION

(75) Inventors: John Thomas O'Bireck, Aurora (CA); Kanwaljit Singh Basra, Oakville (CA); John E. Doughty, Grand Valley (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: HY-DRIVE TECHNOLOGIES LTD., Mississauga, ON (CA)

(21) Appl. No.: 12/514,571

(22) PCT Filed: Jan. 30, 2007
(86) PCT No.: PCT/CA2007/000127

§ 371 Date: May 12, 2009

(30) Foreign Application Priority Data
Jan. 30, 2006 (CA) 2,534,454

(51) Int. Cl. F02B 43/00

(52) U.S. Cl. 123/3

(57) ABSTRACT

A hydrogen generating system operable with an engine of a vehicle including a turbocharger, the hydrogen generating system comprising: an electrolysis assembly including at least one anode and at least one cathode configured to be capable of generating hydrogen gas by application of an electrical current therethrough in an electrolyte and a gas delivery system for delivery of generated hydrogen gas to the engine; and a system for monitoring engine condition in respect of turbocharger condition, the system including a function for detecting an engine turbocharge status and a function for controlling the delivery of generated hydrogen gas to the engine of the vehicle in response to the detection of a selected engine turbocharge status.

### FIELD OF THE INVENTION

The present invention is directed to a hydrogen generating apparatus and in particular a hydrogen generating apparatus for a motor vehicle.

### BACKGROUND

A hydrogen generating system may be used on a vehicle to generate hydrogen gas for supplementing the vehicle's fuel supply for fuel economy, to reduce emissions and/or to increase engine performance.

Hydrogen generating systems have been used on diesel engines in cooperation with turbochargers. It has been discovered that injection of generated hydrogen gas during turbo boost can generate extra power but does not always correlate to fuel economy. In fact, power generation can be enhanced to such a degree by use of a hydrogen generating system that the vehicle driver tends to drive the engine to turbo boost conditions more frequently such that fuel consumption benefits are not realized to the extent expected during use of a hydrogen generating system. This unrealized fuel conservation or tendency for drivers to seek turbo boost conditions, may deter some fleet operators from using hydrogen generating systems in their fleets.

### SUMMARY

According to one aspect of the present invention, there is provided a hydrogen generating system operable with an engine of a vehicle including a turbocharger, the hydrogen generating system comprising: an electrolysis assembly including at least one anode and at least one cathode configured to be capable of generating hydrogen gas by application of an electrical current therethrough in an electrolyte and a gas delivery system for delivery of generated hydrogen gas to the engine; and a system for monitoring engine condition in respect of turbocharger condition, the system including a function for detecting an engine turbocharge status and a function for controlling the delivery of generated hydrogen gas to the engine of the vehicle in response to the detection of a selected engine turbocharge status.

In accordance with another aspect of the present invention, there is provided a method for operating a hydrogen generating system to provide generated hydrogen gas to the fuel system of a vehicle, the vehicle including a turbocharged engine, the method comprising: providing hydrogen gas to the vehicle turbocharged engine for mixing with engine fuel; monitoring engine condition to detect a turbo charge condition; and adjusting hydrogen gas flow to the turbocharged engine in response to a detected turbocharge operation condition.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is a schematic system diagram illustrating the functionality of a system according to the present invention.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

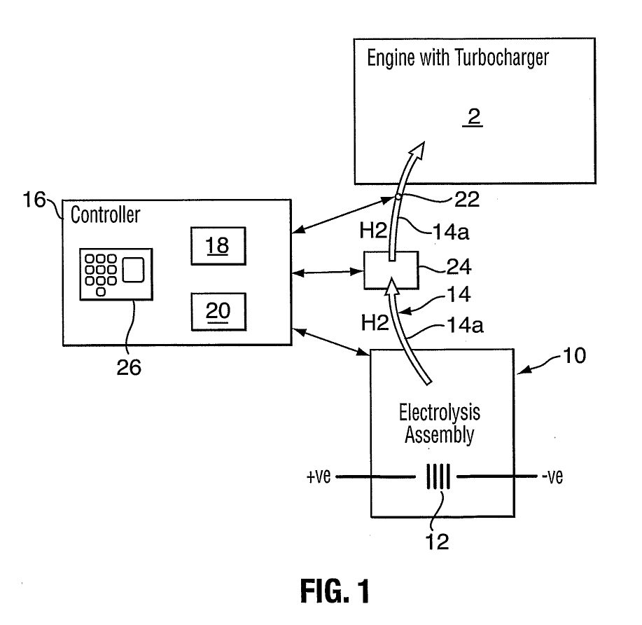

Referring to FIG. 1, a hydrogen generating system according to one embodiment of the present invention is operable with an engine 2 of a vehicle including a turbocharger. Turbocharged engines, as will be appreciated, may operate in various conditions including substantially inactive, turbo lag and turbo boost conditions. For example, in turbo lag condition, the engine generates a feeling of lag when the accelerator is depressed. In this turbo lag condition, the fuel/air mixture is running at an imbalance that consumes fuel with less than optimum power generation. Above standard amounts of emissions are also produced during turbo lag. On the other hand, during a turbo boost condition, significant amounts of compressed air are fed to the engine such that the engine's horsepower can be significantly boosted with the same input of fuel.

Operation of a hydrogen generating system to deliver hydrogen to the engine is believed to be of significant value during normal engine operation when the turbocharger is substantially inactive. When the turbocharger is inactive and the engine is functioning, hydrogen gas from the electrolyzer may be delivered to the engine by production pressures that overcome the engine pressure.

In a hydrogen generating system, it may be useful to monitor an engine's turbocharge condition and adjust hydrogen gas delivery to the engine accordingly. For example, fuel consumption can be decreased and/or power can be increased per fuel unit consumed by introduction of hydrogen gas in a turbo lag condition.

In a turbo boost condition, it may be desirable to limit or discontinue hydrogen gas delivery to the engine if fuel conservation or power limiting is desired. For example, in a turbo boost condition there is sufficient air injected to the engine such that it may not be useful to inject hydrogen gas as well. Although hydrogen gas may assist with fuel conservation in such a condition, the driver may sense the extra power provided by hydrogen gas injection and continue to increase fuel to the engine to further power the vehicle to accelerate it or act against a load (climb a hill or act against a head wind).

Alternately, in some applications where increased power generation is desired, it may be desirable in a turbo boost condition to increase production and delivery of hydrogen gas over a standard operation condition.

A hydrogen generating system may include: an electrolysis assembly 10 including at least one anode and at least one cathode, together identified as 12, configured to be capable of generating hydrogen gas by application of an electrical current therethrough in an electrolyte and a gas delivery system 14 for delivery of generated hydrogen gas to the engine. The hydrogen generating system may further include a control system, indicated generally at 16, for monitoring engine condition in respect of turbocharger condition. The control system may include a function 18 for detecting an engine turbocharge status and a function 20 for controlling the delivery of generated hydrogen gas to the engine of the vehicle in response to the detection of a selected engine turbocharge status.

The control system may include logic, software, electronics, electrical devices, sensors, etc.

The function for determining turbocharge status may take various forms, as will be appreciated. Such function may detect turbocharge status such as, for example, may include turbo lag and/or turbo boost conditions. In one embodiment, the control system includes a gas pressure sensor 22 in or adjacent a hydrogen gas delivery line 14a and positioned to sense back pressure from the engine. Engine back pressure, as evidenced by an increase in pressure at sensor 22, may be indicative of turbocharger operation.

The function for controlling gas delivery from the electrolysis assembly to the engine may include valves, timers, switches, pumps, etc. to control, as by adjusting flow by increasing flow, decreasing flow and/or stopping flow and/or increasing, decreasing or shutting down hydrogen gas generation. In order to deliver hydrogen gas other than when the turbocharger is substantially inactive, it may be necessary to overcome engine back pressure. Thus, a pump 24 may be useful in the delivery line to deliver the hydrogen gas to the engine. Control may be in response to a sensed turbocharge condition and may be initiated either substantially immediately or a set period of time after a turbocharge condition of interest is detected.

In one embodiment, as illustrated, the control system may include a selector 26 so that the operator can select the mode of operation and thereby the manner in which the control system will control hydrogen gas delivery in response to a turbocharge condition. For example the selector may offer an “economy” mode selection and a “performance” mode selection. Of course, the selector may take various forms such as a program selection, a switch, etc. In one embodiment, a hydrogen generating system is provided initially set in the economy mode and a performance mode may only be selected by entry of a pass code to identify that operator's authority to change the mode.

In the “economy” mode, and when the engine is not in any turbo mode, hydrogen gas may be normally delivered, as by the normal flow by pressure of production from the electrolysis cell and/or by use of a pump in the gas delivery line. However, in the “economy” mode, hydrogen gas injection is discontinued after a turbo condition is sensed. In one embodiment, for example, the pump in the hydrogen gas delivery line may be controlled in its operation to deliver hydrogen gas to the engine against the engine's back pressure relative to a sensed a turbo boost condition. Once a turbo operation condition is sensed, the function for controlling gas delivery will operate the pump to drive hydrogen gas into the engine against back pressure during turbo lag and then shut the pump down. The shut down can occur when turbo lag ends or after a short interval, such as less than 30 seconds and possibly less than 15 seconds after a turbo condition, such times relating to a normal turbo lag duration. The pump may then remain shut down until a subsequent turbo boost condition is again sensed wherein it will be started up for a short period, after which it will again be shut down.

“Economy” mode operation then focuses operation of the hydrogen generation system on the period of time when the engine is underloaded or operating under fuel rich conditions to reduce emissions and/or conserve fuel. “Economy” mode, for example, may monitor for a turbo lag condition and may drive the pump to deliver hydrogen gas to the engine when it is in turbo lag and the engine can make most use of the hydrogen gas, with respect to economics.

In one embodiment, the system may also operate to shut down the electrolyzer operation when the engine is operating in turbo boost. As such, hydrogen gas generation may be shut down altogether when the engine is operating in turbo boost so that no hydrogen gas builds up against the engine back pressure. The system may restart the electrolysis process when turbo boost conditions are no longer sensed.

In a “performance” mode, the hydrogen generating system may be as described above but may be selected to deliver gas to the engine for a period longer, for example at least 2 to 20 times longer, than that period that the pump is operated after a sensed turbo boost condition in the “economy” mode. In the performance mode, the system may, if desired, be selected to continue hydrogen gas delivery, as by driving the pump in the delivery line, to the engine continuously during turbo boost. The electrolysis operation may be discontinued with the shut down of the pump, if desired, or may continue regardless of pump operation, if desired.

In one possible embodiment, the hydrogen generating system may be capable of operating under a “performance” mode wherein the system continues to deliver hydrogen gas to the engine during a turbo boost condition and the system may be further capable of increasing power to the electrolysis cell to increase hydrogen gas generation so that increased amounts of hydrogen gas may be delivered to the engine during a turbo boost condition. In such an embodiment, it may be desirable to monitor engine capacity and feed this information back to the hydrogen generating system.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A hydrogen generating system operable with an engine of a vehicle including a turbocharger, the hydrogen generating system comprising: an electrolysis assembly including at least one anode and at least one cathode configured to be capable of generating hydrogen gas by application of an electrical current therethrough in an electrolyte and a gas delivery system for delivery of generated hydrogen gas to the engine; and a system for monitoring engine condition in respect of turbocharger condition, the system including a function for detecting an engine turbocharge status and a function for controlling the delivery of generated hydrogen gas to the engine of the vehicle in response to the detection of a selected engine turbocharge status.

2. The hydrogen generating system of claim 1 wherein the function for detecting an engine turbocharge status is capable of detecting a turbocharger operation condition.

3. The hydrogen generating system of claim 1 wherein the function for detecting an engine turbocharge status operates with a gas pressure sensor positioned to sense back pressure from the engine.

4. The hydrogen generating system of claim 1 wherein the function for controlling gas delivery operates by adjusting flow of hydrogen gas to the engine.

5. The hydrogen generating system of claim 4 wherein adjusting flow includes increasing flow.

6. The hydrogen generating system of claim 4 wherein adjusting flow includes decreasing flow.

7. The hydrogen generating system of claim 4 wherein adjusting flow includes stopping flow.

8. The hydrogen generating system of claim 4 wherein adjusting flow includes increasing hydrogen gas generation.

9. The hydrogen generating system of claim 4 wherein adjusting flow includes decreasing hydrogen gas generation.

10. The hydrogen generating system of claim 4 wherein adjusting flow includes shutting down hydrogen gas generation.

11. The hydrogen generating system of claim 1 wherein the gas delivery system includes a pump to deliver the hydrogen gas to the engine.

12. The hydrogen generating system of claim 1 wherein the function for controlling the delivery of generated gas may operate in response to a sensed turbocharge condition and may initiate control substantially immediately or a selected period of time after the selected engine turbocharge status is detected.

13. The hydrogen generating system of claim 1 wherein the system for monitoring engine condition includes a function for selecting the mode of operation.

14. The hydrogen generating system of claim 1 wherein the function for selecting includes an economy mode selection wherein hydrogen gas injection is discontinued after the selected engine turbocharge status is sensed.

15. The hydrogen generating system of claim 14 wherein the economy mode selection causes a pump in the gas delivery system to be shut down after the selected engine turbocharge status is sensed.

16. The hydrogen generating system of claim 14 wherein the economy mode selection causes a pump in the gas delivery system to be operated for a period of time and then shut down after the selected engine turbocharge status is sensed.

17. The hydrogen generating system of claim 14 wherein the economy mode selection causes hydrogen gas generation to be shut down after the selected engine turbocharge status is sensed.

18. The hydrogen generating system of claim 1 wherein the economy mode selection is the default.

19. The hydrogen generating system of claim 1 wherein the function for selecting includes a performance mode selection wherein hydrogen gas delivery is continued after the selected engine turbocharge status is sensed.

20. The hydrogen generating system of claim 19 wherein the performance mode selection causes a pump in the gas delivery system to deliver hydrogen gas during a turboboost condition but shuts the pump down a period of time after the selected engine turbocharge status is sensed.

21. The hydrogen generating system of claim 19 wherein the performance mode selection increases power to the electrolysis cell to increase hydrogen gas during a turbo boost condition.

22. A method for operating a hydrogen generating system to provide generated hydrogen gas to the fuel system of a vehicle, the vehicle including a turbocharged engine, the method comprising: providing hydrogen gas to the vehicle turbocharged engine for mixing with engine fuel; monitoring engine condition to detect a turbo charge condition; and adjusting hydrogen gas flow to the turbocharged engine in response to a detected turbocharge operation condition.

23. The method for operating a hydrogen generating system of claim 22 wherein monitoring includes sensing back pressure from the engine.

24. The method for operating a hydrogen generating system of claim 22 wherein monitoring includes sensing gas pressure of the hydrogen gas being injected to the engine.

25. The method for operating a hydrogen generating system of claim 22 wherein adjusting flow includes increasing flow.

26. The method for operating a hydrogen generating system of claim 22 wherein adjusting flow includes decreasing flow.

27. The method for operating a hydrogen generating system of claim 22 wherein adjusting flow includes stopping flow.

28. The method for operating a hydrogen generating system of claim 22 wherein adjusting flow includes increasing hydrogen gas generation.

29. The method for operating a hydrogen generating system of claim 22 wherein adjusting flow includes decreasing hydrogen gas generation.

30. The method for operating a hydrogen generating system of claim 22 wherein adjusting flow includes shutting down hydrogen gas generation.

31. The method for operating a hydrogen generating system of claim 22 wherein providing hydrogen gas to the vehicle includes pumping the hydrogen gas to the engine.

32. The method for operating a hydrogen generating system of claim 22 wherein adjusting hydrogen gas flow may be initiated substantially immediately or a selected period of time after a turbocharge operation condition is detected.

33. The method for operating a hydrogen generating system of claim 22 further comprising selecting a mode of operation for the hydrogen generating system selected for economizing fuel consumption by adjusting hydrogen gas flow.

34. The method for operating a hydrogen generating system of claim 22 further comprising selecting a mode of operation for the hydrogen generating system selected to increase power generation from the engine by adjusting hydrogen gas flow during the turbocharge operation condition.

35. The method for operating a hydrogen generating system of claim 22 wherein adjusting includes discontinuing hydrogen gas injection to the engine after the turbocharge operation condition is sensed.

36. The method for operating a hydrogen generating system of claim 22 wherein adjusting includes discontinuing pumping of hydrogen gas to the engine after the turbocharge operation condition is sensed.

37. The method for operating a hydrogen generating system of claim 22 wherein adjusting includes starting a pump to inject hydrogen gas against engine back pressure when turbocharge operation condition is sensed

38. The method for operating a hydrogen generating system of claim 37 wherein adjusting further includes discontinuing operation of the pump a selected period of time after starting the pump.

39. The method for operating a hydrogen generating system of claim 22 wherein adjusting includes discontinuing hydrogen generation after the turbocharge operation condition is sensed.

40. The method for operating a hydrogen generating system of claim 22 wherein adjusting includes continuing hydrogen generation after the turbocharge operation condition is sensed.

41. The method for operating a hydrogen generating system of claim 22 wherein adjusting causes a pump in the gas delivery system to deliver hydrogen gas during a turboboost condition but shuts the pump down a period of time after the turboboost condition is sensed.

42. The method for operating a hydrogen generating system of claim 22 wherein adjusting includes increasing power to an electrolysis cell to increase hydrogen gas production during a turbo boost condition.
